(19) United States
(12) Patent Application Publication
(10) Pub. No.: US 2016/0041689 A1
(43) Pub. Date: Feb. 11, 2016

(54) TOUCH PANEL SYSTEM

(71) Applicant: SHARP KABUSHIKI KAISHA, Osaka (JP)

(72) Inventors: Manabu YUMOTO, Osaka-shi (JP); Shunsuke NAGASAWA, Osaka-shi (JP); Masayuki YAMAGUCHI, Osaka-shi (JP)

(73) Assignee: SHARP KABUSHIKI KAISHA, Osaka-shi, Osaka (JP)

(21) Appl. No.: 14/775,063

(22) PCT Filed: Jan. 30, 2014
(86) PCT No.: PCT/JP2014/052119

§ 371 Date: Sep. 11, 2015

(30) Foreign Application Priority Data
Mar. 15, 2013 (JP) 2013-054278

(51) Int. Cl. G06F 3/041; G06F 3/044

(52) U.S. Cl. CPC G06F 3/0418; G06F 3/044

(57) ABSTRACT

A touch panel system (1) includes a touch panel (3) and a touch position detecting section (5) for detecting a touch position on the touch panel (3). The touch position detecting section (5) includes a touch information compensating section (56). In a case where a period from detection of a certain touch position to detection of a next touch position during a continuous touch operation is longer than a first period (t) and is shorter than a second period (T; and T>t), the touch information compensating section (56) (i) determines that a touch position detection result is missing and (ii) compensates a piece of touch information of a missing touch position between the certain touch position and the next touch position.

### TECHNICAL FIELD

The present invention relates to a touch panel system and an electronic device including the touch panel system. In particular, the present invention relates to (i) a touch panel system which can accurately recognize a touch operation even in a case where a touch position detection result is missing during the touch operation, and (ii) an electronic device including the touch panel system.

### BACKGROUND ART

At present, applications of a touch panel system to various electronic devices, e.g., a mobile information device such as a smartphone and a vending machine such as a ticket bending machine, have rapidly been increased.

A touch panel mainly used in such a touch panel system has been a resistive film type touch panel. However, in recent years, a projected capacitive type touch panel is becoming popular because of its capability of accepting multi-touch.

As an example of such a touch panel system, Patent Literature 1 discloses a command input device. The command input device includes a touch panel, a touch time detecting section, a touch frequency detecting section, a touch interval detecting section, and an input command determining section. The touch time detecting section detects time during which a finger is continuously making contact with the touch panel. The touch frequency detecting section detects the number of times that the finger touches the touch panel. The touch interval detecting section detects an interval from when the finger is off from the touch panel and to when the finger makes contact with the touch panel. The input command determining section determines an input command on the basis of detection results of the touch time detecting section, the touch frequency detecting section, and the touch interval detecting section.

FIG. 7 is a flowchart for describing an operation of the command input device disclosed in Patent Literature 1. As illustrated in FIG. 7, the command input device is arranged such that: (i) a command can be inputted on the basis of time, a frequency, and an interval of touch by the finger to the touch panel (S501 to 507); (ii) a command is determined on the basis of the inputted command (S508); (iii) an operation is selected on the basis of the determined command (S509); and (iv) the touch panel is controlled in accordance with the selected operation (S510).

### CITATION LIST

### Patent Literature

Patent Literature 1

Japanese Patent Application Publication, Tokukai, No. 2004-362429 (Publication Date: Dec. 24, 2004)

### SUMMARY OF INVENTION

### Technical Problem

However, a conventional touch panel system has such a problem that the conventional touch panel system cannot accurately recognize a touch operation in a case where a piece of touch information is missing during the touch operation.

Specifically, the conventional touch panel system detects a touch position at every predetermined time so that a continuous touch operation is recognized. From this, in a case where, for example, an actual touch position has not been detected due to noise or the like, a piece of touch information relating to the actual touch position is missing, and this causes erroneous recognition of a touch operation.

The command input device disclosed in Patent Literature 1 is intended to be applied to a car navigation device. The command input device determines an inputted command on the basis of continuous touch time, a touch frequency, and a touch time interval, with respect to the touch panel. From this, a driver does not need to look at the touch panel when inputting a command while driving, and the driver can accurately input a command even in a case where a vehicle is shaking. With the arrangement, in a case where a piece of touch information is missing in the command input device, the continuous touch time, the touch frequency, and the touch time interval with respect to the touch panel become less than their actual ones, and therefore an intended input command cannot be executed. From this, the command input device also erroneously recognizes a touch operation in a case where a piece of touch information is missing.

The present invention is attained in view of the above conventional problem. An object of the present invention is to provide a touch panel system and the like that can accurately recognize a touch operation even in a case where a piece of touch information is missing during the touch operation.

### Solution to Problem

In order to attain the above object, a touch panel system according to an aspect of the present invention is a touch panel system including: a touch panel; and a touch position detecting section for detecting a touch position on the touch panel, the touch position detecting section including a touch information compensating section, and in a case where a period from detection of a certain touch position to detection of a next touch position during a continuous touch operation is longer than a first period (t) and within a second period (T; and T>t), the touch information compensating section (i) determining that a touch position detection result is missing and (ii) compensating a piece of touch information of a missing touch position between the certain touch position and the next touch position.

### Advantageous Effects of Invention

According to an aspect of the present invention, it is possible to accurately recognize a touch operation even in a case where a piece of touch information is missing during the touch operation.

### BRIEF DESCRIPTION OF DRAWINGS

FIG. 1 is a view schematically illustrating a touch panel system according to Embodiment 1 of the present invention.

FIG. 2 is a block diagram illustrating a touch information compensating section of the touch panel system illustrated in FIG. 1.

FIG. 3 is a flowchart illustrating a process of the touch information compensating section of the touch panel system illustrated in FIG. 1.

FIG. 4 is a view schematically illustrating the process of the touch information compensating section of the touch panel system illustrated in FIG. 1.

FIG. 5 is a flowchart illustrating a process of the touch information compensating section of the touch panel system according to Embodiment 2 of the present invention.

FIG. 6 is a view schematically illustrating the process of the touch information compensating section of the touch panel system according to Embodiment 2 of the present invention.

FIG. 7 is a block diagram illustrating a configuration of a mobile phone according to Embodiment 3 of the present invention.

FIG. 8 is a flowchart for describing an operation of a command input device disclosed in Patent Literature 1.

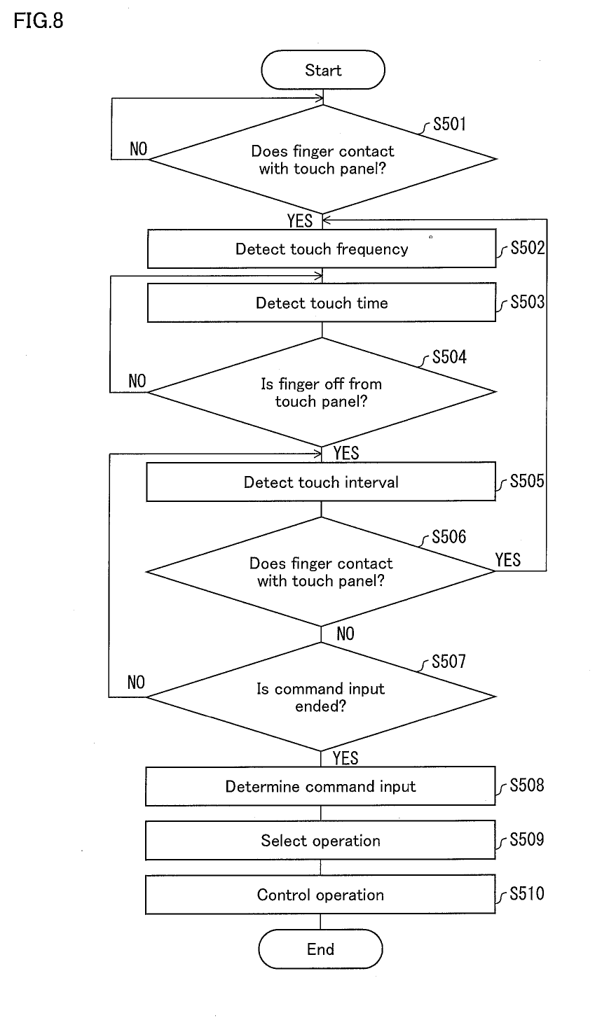

### DESCRIPTION OF EMBODIMENTS

(Configuration of Touch Panel System 1)

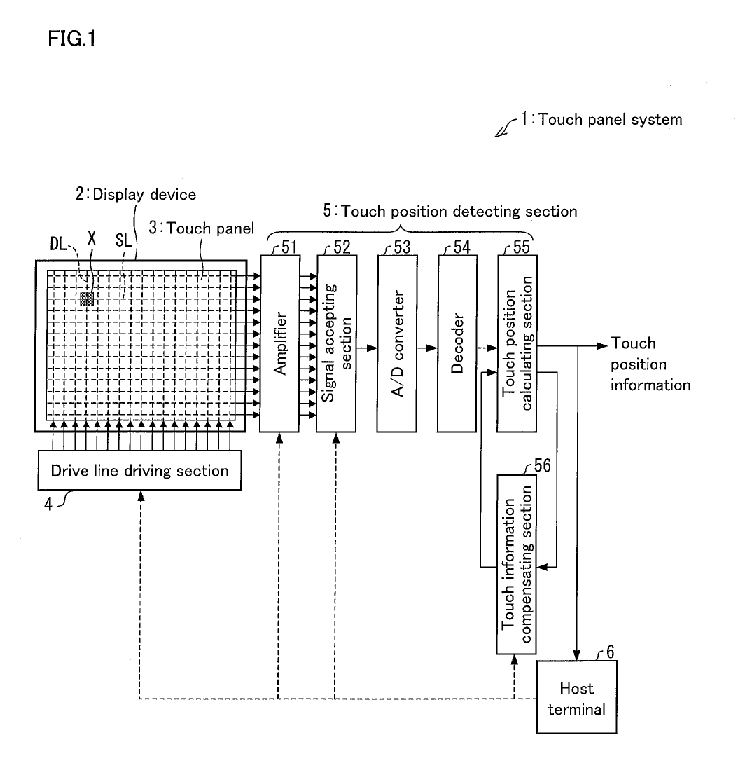

The following discusses embodiments of the present invention in detail. FIG. 1 is a view schematically illustrating a basic configuration of a touch panel system 1 according to Embodiment 1 of the present invention. As illustrated in FIG. 1, the touch panel system 1 includes a display device 2, a touch panel 3, a drive line driving section 4, a touch position detecting section 5, and a host terminal 6. The following description assumes that a side on which a user carries out a touch operation is a front surface (or an upper side).

The display device 2 has a display surface on which various icons for operations, character information corresponding to operational instructions by the user, and the like are to be displayed. The display device 2 is made up of, for example, a liquid crystal display, a plasma display, an organic EL display, a field emission display (FED), or the like. These displays are widely used in electrical devices for daily use, so that the touch panel system 1 has high versatility. The display device 2 can be arbitrarily configured, and an arrangement of the display device 2 is not specifically limited. Further, it is preferable that the display device 2 have, as its thin film transistors (TFTs), TFTs whose semiconductor layer is made of so-called oxide semiconductor. The oxide semiconductor encompasses, for example, an InGaZnO-based oxide semiconductor. The display device 2 having the InGaZnO-based oxide semiconductor can realize display of a high definition image with greatly reduced electric power consumption.

To the touch panel 3, the user inputs various operational instructions by carrying out a touch (push) operation with respect to a surface of the touch panel 3 with an indicator such as his/her finger or a pen. The touch panel 3 is stacked on the front surface (upper surface) of the display device 2 so as to cover the display surface of the display device 2. In the present embodiment, a projected capacitive type touch panel is used as the touch panel 3. The capacitive touch panel 3 has advantages such as high light transmittance and high durability. However, a type of the touch panel 3 is not limited to the projected capacitive type and can be another type. The type of the touch panel 3 can be, for example, a resistive film type, an electromagnetic inductive type, an ultrasonic surface acoustic wave type, or an infrared scanning type.

Specifically, the touch panel 3 includes a plurality of drive lines DL which are provided along the display surface so as to be parallel to each other, and a plurality of sense lines SL which are provided along the display surface so as to be parallel to each other and intersect with the plurality of drive lines DL in a grade separation manner. At each of intersections of the plurality of drive lines DL and the plurality of sense lines SL, a capacitor is formed. The plurality of drive lines DL and the plurality of sense lines SL can be made of, for example, (i) a transparent wiring material such as indium tin oxide (ITO) or (ii) a metallic mesh. The plurality of drive lines DL and the plurality of sense lines SL are connected to the display device 2 (a panel unit which constitutes a part of the display surface). Note that FIG. 1 deals with an example in which the plurality of drive lines DL and the plurality of sense lines SL vertically intersect with each other in a grade separation manner, but the plurality of drive lines DL and the plurality of sense lines SL can alternatively intersect with each other in a grade separation manner at any angle other than a vertical direction.

The drive line driving section 4 is connected with the plurality of drive lines DL and, when the touch panel system 1 is activated, the drive line driving section 4 applies electrical potentials to the plurality of the drive lines DL at constant intervals. The drive line driving section 4 causes the plurality of sense lines SL, which intersect with the plurality of drive lines DL in the grade separation manner, to generate condition signals by driving the plurality of drive lines DL. The condition signal is a signal which indicates a condition of a touch at or near the intersections (hereinafter, referred to as a “detection region” (detection region X illustrated in FIG. 1)) of the plurality of drive lines DL and the plurality of sense lines SL on the touch panel 3.

A value of the condition signal varies in accordance with the capacitance between the drive line DL and the sense line SL, and indicates whether the indicator is in contact with or is being near to the detection region X on the touch panel 3. That is, the condition signal indicates (i) the presence or absence of the indicator being in contact with or being near to the detection region X, (ii) a distance between the detection region X and the indicator, or the like. Note that, as the indicator comes closer to the detection region X or when the indicator is in contact with the detection region X, the capacitance becomes smaller.

The touch position detecting section 5 processes a signal supplied from the touch panel 3 so as to detect a touch position. That is, the touch position detecting section 5 detects a position of the touch by the indicator, which is in contact with or is being near to the display surface, by processing the condition signal generated on the sense line SL. The touch position detecting section 5 includes, from a touch panel 3 side, an amplifier 51, a signal accepting section 52, an A/D converter 53, a decoder 54, a touch position calculating section 55, and a touch information compensating section 56 in this order.

The amplifier 51 amplifies the condition signals generated on the plurality of sense lines SL. The signal accepting section 52 accepts the condition signals amplified by the amplifier 51 and supplies the amplified condition signals in a time division manner. The A/D converter 53 converts the condition signals, which have been supplied from the signal accepting section 52 and are analog signals, into respective digital signals. The decoder 54 calculates, on the basis of the digital signals converted by the A/D converter 123, a changed amount of capacity distribution in the touch panel 3. The touch position calculating section 55 calculates, on the basis of the changed amount of the capacity distribution calculated by the decoder 54, a position of the touch on the touch panel 3, and then generates touch position information indicative of the calculated position of the touch. In a case where a piece of touch information is missing during a continuous touch operation, the touch information compensating section 56 compensates the missing piece of touch information. The touch information compensating section 56 will be described later in detail.

The host terminal 6 controls the plurality of drive lines DL which are driven by the drive line driving section 4. The host terminal 6 also controls the plurality of sense lines SL which generate the condition signals to be processed by the touch position detecting section 5. The following description deals with an example in which the host terminal 6 controls the plurality of drive lines DL and the plurality of sense lines SL. Note, however, that the host terminal 6 can alternatively control only the plurality of drive lines DL or the plurality of sense lines SL.

(Basic Operation of Touch Panel System 1)

Next, the following discusses an example of a basic operation of the touch panel system 1 with reference to FIG. 1. Note that the following discusses a single trial operation in which the touch panel system 1 detects an indicator that is in contact with or is being near to the touch panel 3.

First, the drive line driving section 4 drives the plurality of drive lines DL so that condition signals are generated on the plurality of sense lines SL. Next, the amplifier 51 amplifies the condition signals generated on the plurality of sense lines SL. Further, the signal accepting section 52 supplies the condition signals, which have been amplified by the amplifier 51, in a time division manner. Note that the host terminal 6 controls operation of each of the drive line driving section 4, the amplifier 51, and the signal accepting section 52. That is, the host terminal 6 controls the plurality of drive lines DL to be driven and the plurality of sense lines SL on which condition signals to be processed are generated.

Next, the A/D converter 53 converts the analog signals, which have been supplied from the signal accepting section 52, into respective digital signals each having a predetermined number of bits. Subsequently, the decoder 54 calculates, on the basis of the digital signals converted by the A/D converter 53, a changed amount of capacity distribution in the touch panel 3. For example, before a touch operation is detected, the decoder 54 obtains digital signals indicative of a case where a touch subject (indicator) does not exist on the touch panel 3 and calculates in advance capacity distribution of the case where the touch subject (indicator) does not exist on the touch panel 3. The decoder 54 then receives from the A/D converter 53 digital signals indicative of a case where the indicator has been detected and calculates capacity distribution of the case where the indicator is present. After that, the decoder 54 compares the pre-calculated capacity distribution of the case where the touch subject is absent with the capacity distribution of the case where the touch subject is present, so as to calculate a changed amount of the capacity distribution. This changed amount of the capacity distribution can be rephrased as an amount by which capacitance is changed due to the touch subject (indicator).

The touch position calculating section 55 calculates, on the basis of the changed amount of the capacity distribution calculated by the decoder 54, a position of the touch subject on the touch panel 3, and generates touch position information. The touch position calculating section 55 calculates the position of the touch subject on the touch panel 3 by, for example, determining that the touch subject exists at a position at which the changed amount of the capacitance is larger than a threshold for determining a touch. The touch position calculating section 55 calculates a touch position of each time point detected at a predetermined scanning cycle.

The touch information compensating section 56 (i) determines whether or not there is a touch position missing from the touch positions calculated by the touch position calculating section 55 and, in a case where there is a missing touch position, (ii) compensates a piece of touch information relating to the missing touch position.

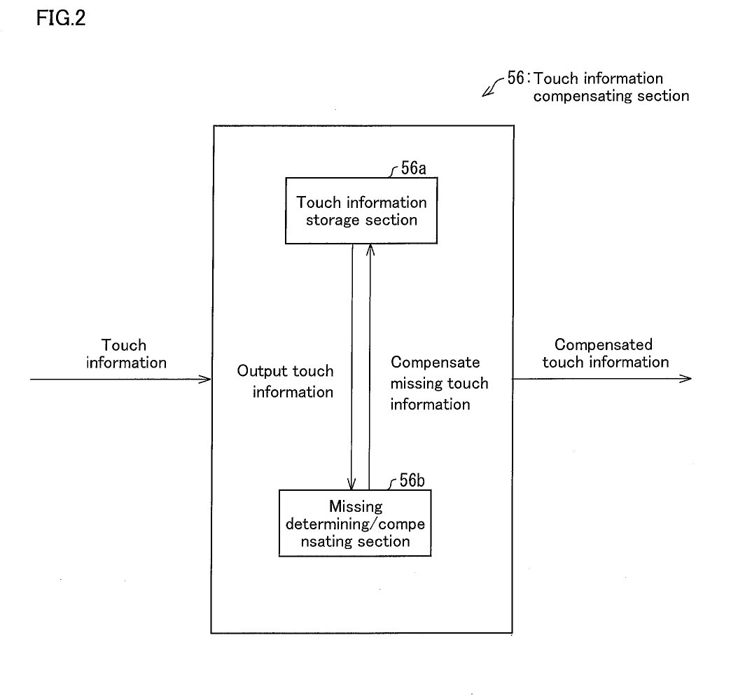

Next, the following discusses an example of the touch information compensating section 56 with reference to FIG. 2. FIG. 2 is a block diagram illustrating an arrangement of the touch information compensating section 56 in the touch panel system 1 illustrated in FIG. 1. As illustrated in FIG. 2, the touch information compensating section 56 includes a touch information storage section 56a and a missing determining/compensating section 56b.

The touch information storage section 56a stores therein pieces of touch information relating to the respective touch positions calculated by the touch position calculating section 55. Specifically, the touch information storage section 56a stores therein, together with relative time of the calculated touches, pieces of positional information (such as touch position coordinates) of the respective calculated touches. From this, in a case where a continuous touch operation is carried out on the touch panel 3, the touch information storage section 56a continuously stores therein pieces of touch information during the continuous touch operation. Consequently, the touch information storage section 56a stores therein pieces of touch information in real time.

The missing determining/compensating section 56b reads out the pieces of touch information stored in the touch information storage section 56a. In a case where noise or the like occurs during the continuous touch operation, an actual touch position is not detected and a piece of touch information relating to the actual touch position is missing. In such a case, the missing piece of touch information is not stored in the touch information storage section 56a. In view of this, the missing determining/compensating section 56b (i) determines whether or not a touch position detection result (touch information) is missing and (ii) compensates the missing piece of touch information in the touch information storage section 56a. The process of the missing determining/compensating section 56b will be described later in detail.

The touch panel system 1 continuously detects the indicator that is the touch subject by repeating the trial operation described above.

With reference to the touch position information supplied from the touch position calculating section 55 as necessary, the host terminal 6 can control each section of the drive line driving section 4 and the touch position detecting section 5. Further, the host terminal 6 can control a frame rate, which is the number of times that the touch position detecting section 5 attempts to detect a touch subject per unit time (e.g., per second). That is, in the touch panel system 1, the host terminal 6 can arbitrarily control settings of (i) the plurality of drive lines DL which are supposed to be driven by the drive line driving section 4, (ii) the plurality of sense lines SL on which the condition signals to be processed by the touch position detection section 5 are supposed to be generated, (iii) the frame rate, (iv) detection sensitivity, and the like.

(Process of Touch Information Compensating Section 56)

Next, the following discusses in detail the touch information compensating section 56 which is a characteristic feature of the touch panel system 1. In the touch panel system 1, the touch position detecting section 5 detects a touch position at every predetermined time, so that a touch position at a certain time point is recognized. In a case where noise or the like occurs during a continuous touch operation, an actual touch position is not detected and a piece of touch information relating to the actual touch position is lost. Alternatively, in a case where a touch to the touch panel 3 is disturbed due to, for example, damage to the touch panel 3 and/or water droplets or dust adhering to the touch panel 3, a piece of touch information relating to a touch position is caused to be missing. That is, a state may occur in which touch positions are partially not recognized during a continuous touch operation by the indicator (i.e., a state in which touch operations are partially not recognized even though a touch operation is being carried out by the indicator). As a result, a touch operation may not be accurately recognized.

As a measure against the missing of touch information caused due to noise or the like, the touch panel system 1 includes the touch information compensating section 56. In a case where a piece of touch information is missing during a continuous touch operation, the touch information compensating section 56 compensates the missing piece of touch information.

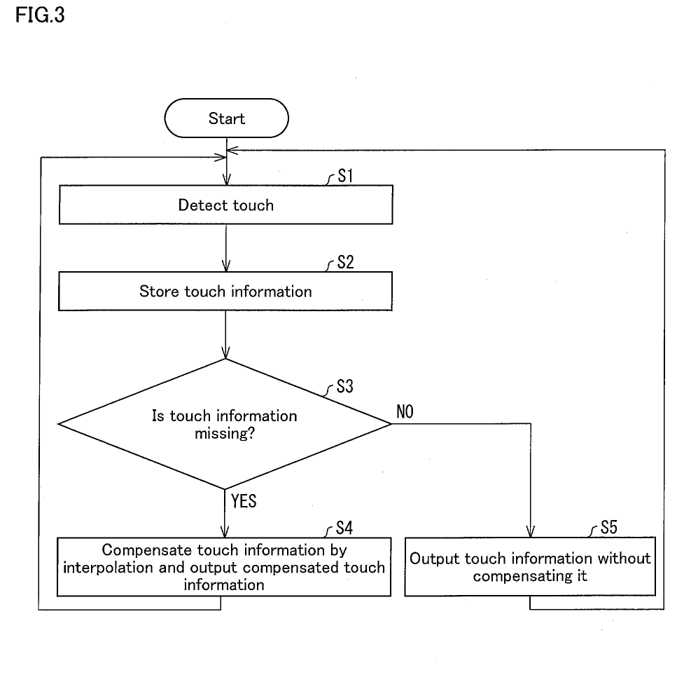

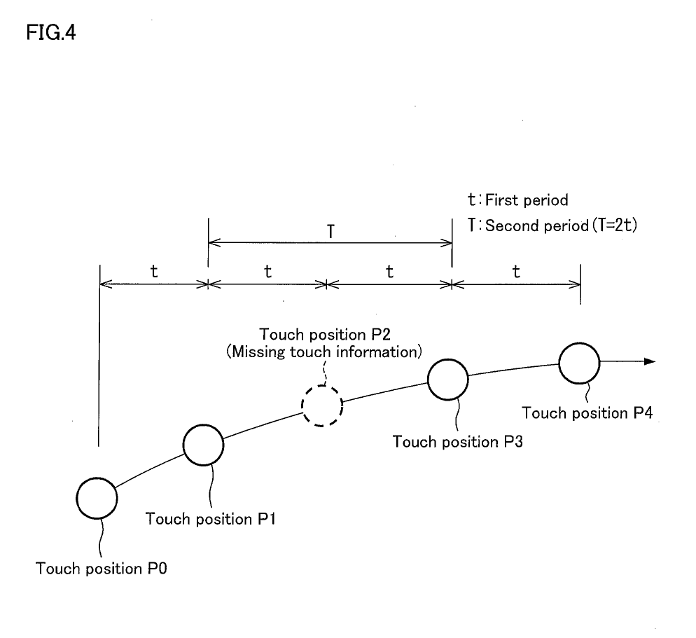

The following discusses, with reference to FIGS. 3 and 4, a process example in which the touch information compensating section 56 compensates the missing piece of touch information. FIG. 3 is a flowchart illustrating a process of the touch information compensating section 56 of the touch panel system 1 illustrated in FIG. 1. FIG. 4 is a view schematically illustrating the process of the touch information compensating section 56 of the touch panel system 1 illustrated in FIG. 1.

As illustrated in FIG. 3, the touch position detecting section 5 processes a signal, supplied from the touch panel 3, at a predetermined scanning cycle so as to detect a touch position (S1). Specifically, when a touch operation is carried out with respect to the touch panel 3, the touch position calculating section 55 (i) calculates a current touch position on the basis of a changed amount of capacitance of the touch panel 3, and (ii) supplies a result of the calculation to the touch information compensating section 56 (touch information storage section 56a).

Next, the touch information storage section 56a stores therein the touch information (e.g., relative time, coordinates, and the like of the detected touch position) calculated by the touch position calculating section 55 (S2). In a case where a continuous touch operation is carried out on the touch panel 3, the touch position detecting section 5 continuously detects touches during the touch operation, and accordingly, the touch information storage section 56a continuously stores therein pieces of touch information during the touch operation.

Next, the missing determining/compensating section 56b (i) reads out the pieces of touch information stored in the touch information storage section 56a, (ii) determines whether or not a piece of touch information is missing during the continuous touch operation and, in a case where a piece of touch information is missing, compensates the piece of touch information thus missing (S3 through S5).

Here, the following discusses the process of the missing determining/compensating section 56b (S3 through S5 of FIG. 3) in detail with reference to FIG. 4. FIG. 4 illustrates an example of a continuous touch operation detected in the touch panel system 1 of FIG. 1. That is, FIG. 4 illustrates an example in which (i) touch positions are detected at a touch position P₀, →a touch position P₁, →a touch position P₃→a touch position P₄ . . . in this order, and (ii) a piece of touch information of a touch position P₂ is missing.

The missing determining/compensating section 56b first reads out the pieces of touch information stored in the touch information storage section 56a at every first period (t). In a case where a period from detection of a certain touch position to detection of a next touch position is (i) longer than the first period (t) and (ii) within a second period (T; and T>t), the missing determining/compensating section 56b determines that a piece of touch information (touch position detection result) is missing. In the example of FIG. 4, the missing determining/compensating section 56b sets (i) a scanning cycle as the first period (t) and, (ii) as the second period (T), a period that is twice the scanning cycle. That is, the missing determining/compensating section 56b (i) reads out a piece of touch information at every scanning cycle (t=scanning cycle) and (ii) checks whether or not a period (interval) from (a) a piece of touch information having been read out at a certain time point to (b) another piece of touch information having been read out subsequently to the certain time point is within twice the scanning cycle (T=2t=scanning cycle×2), so as to determine whether or not a piece of touch information is missing. In FIG. 4, (i) no touch information is detected t second(s) after detection of a piece of touch information of the touch position P₁ and (ii) a piece of touch information of the touch position P₃ is detected 2t second(s) after the detection of the piece of touch information of the touch position P₁. In this case, the missing determining/compensating section 56b determines that a piece of touch information of the touch position P₂ is missing (YES in S3).

In such a case where the piece of touch information is missing, the missing determining/compensating section 56b compensates the missing piece of touch information and outputs the compensated piece of touch information to the touch information storage section 56a (S4). The touch information storage section 56a stores therein the compensated piece of touch information thus outputted from the missing determining/compensating section 56b.

The touch panel system 1 of the present embodiment compensates a piece of touch information of a missing touch position (touch position P₂) by interpolation using pieces of touch information of touch positions (touch position P₁, touch position P₃) respectively detected before and after the missing touch position (touch position P₂). Specifically, the missing determining/compensating section 56b calculates the piece of touch information of the missing touch position (touch position P₂) by averaging the touch position P₁ and the touch position P₃. For example, in a case where the touch position P₁ has xy coordinates of (x1, y1) and the touch position P₃ has xy coordinates of (x3, y3), the missing determining/compensating section 56b calculates xy coordinates (x2, y2) of the missing touch position P₂ as ({x1+x3}/2, {y1+y3}/2). Then, the missing determining/compensating section 56b compensates the piece of touch information of the missing touch position P₂ (x2, y2) by the xy coordinates ({x1+x3}/2, {y1+y3}/2) thus calculated.

In contrast, in a case where (i) the piece of touch information of the touch position P₂ is detected t second(s) after the detection of the piece of touch information of the touch position P₁ and (ii) the piece of touch information of the touch position P₃ is detected 2t second(s) after the detection of the touch position P₁ in FIG. 4, the missing determining/compensating section 56b determines that no touch information is missing (NO in S3). In this case, the missing determining/compensating section 56b outputs the pieces of touch information of the continuous touch operation without compensating any piece of touch information (S5).

Note that, in a case where another piece of touch information is detected subsequent to the second period (T) after the detection of the touch position P₁ in FIG. 4, the missing determining/compensating section 56b determines that a touch operation including the another piece of touch information is separated from the touch operation including the touch position P₀→the touch position P₁ (this case is not particularly illustrated). Meanwhile, in a case where no touch information is detected subsequent to the second period (T) after the detection of the touch position P₁ in FIG. 4, the missing determining/compensating section 56b determines that the continuous touch operation is ended at the touch position P₁.

By repeating the above processes, the touch panel system 1 recognizes a continuous touch operation, and compensates a piece of touch information if any piece of touch information is missing. Note that the first period (t) and the second period (T), which are set by the missing determining/compensating section 56b, are not limited to the above example. A person skilled in the art would be able to set the first period (t) and the second period (T) based on empirical rules.

The touch panel system 1 of the present embodiment compensates a missing piece of touch information by interpolation (averaging). However, a method for compensating touch information is not limited to a particular one.

As described above, the touch panel system 1 includes the touch position detecting section 5 including the touch information compensating section 56 which, in a case where a period from detection of a certain touch position to detection of a next touch position during a continuous touch operation is longer than the first period (t) and within the second period (T; and T>t), (i) determines that a touch position detection result is missing and (ii) compensates a piece of touch information of the missing touch position between the certain touch position and the next touch position.

That is, according to the touch panel system 1, the touch information compensating section 56 (touch information storage section 56a, missing determining/compensating section 56b) determines, based on detection times of two touch positions that have been successively detected during a continuous touch operation, whether or not a touch position detection result is missing (i.e., presence or absence of a missing piece of touch information). In a case where the touch information compensating section 56 determines that there is a missing touch position, the touch information compensating section 56 compensates a piece of touch information relating to the missing touch position (touch position P₂) between the two touch positions (touch position P₁, touch position P₃). Consequently, it is possible to accurately recognize a touch operation even in a case where the touch position detection result (touch information) is missing during the touch operation.

Further, the touch information compensating section 56 (missing determining/compensating section 56b) of the touch panel system 1 compensates the piece of touch information of the missing touch position (touch position P₂) by interpolation (specifically, averaging) using pieces of touch information of touch positions (touch position P₁, touch position P₃) respectively detected before and after the missing touch position (touch position P₂). This makes it possible to compensate the piece of touch information of the missing touch position (touch position P₂) with high accuracy even in a case where the touch positions (touch position P₁, the touch position Pa) respectively detected before and after the missing touch position notably vary. Further, since the touch information compensating section 56 calculates the piece of touch information of the missing touch position (touch position P₂) by averaging, a setting process for the piece of touch information of the missing touch position (touch position P₂) is simplified. It is therefore possible to rapidly compensate the piece of touch information relating to the missing touch position (touch position P₂) with high accuracy.

### Embodiment 2

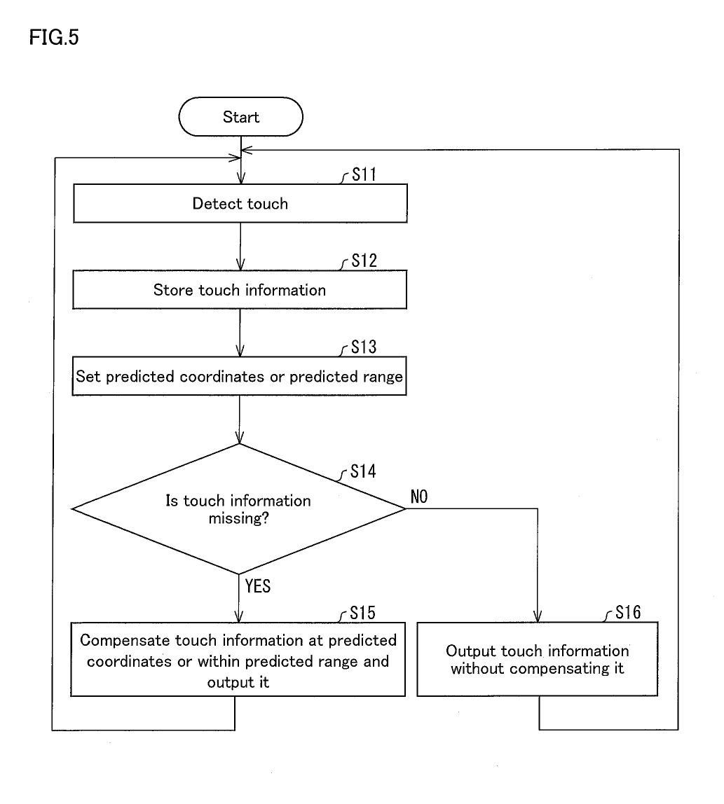

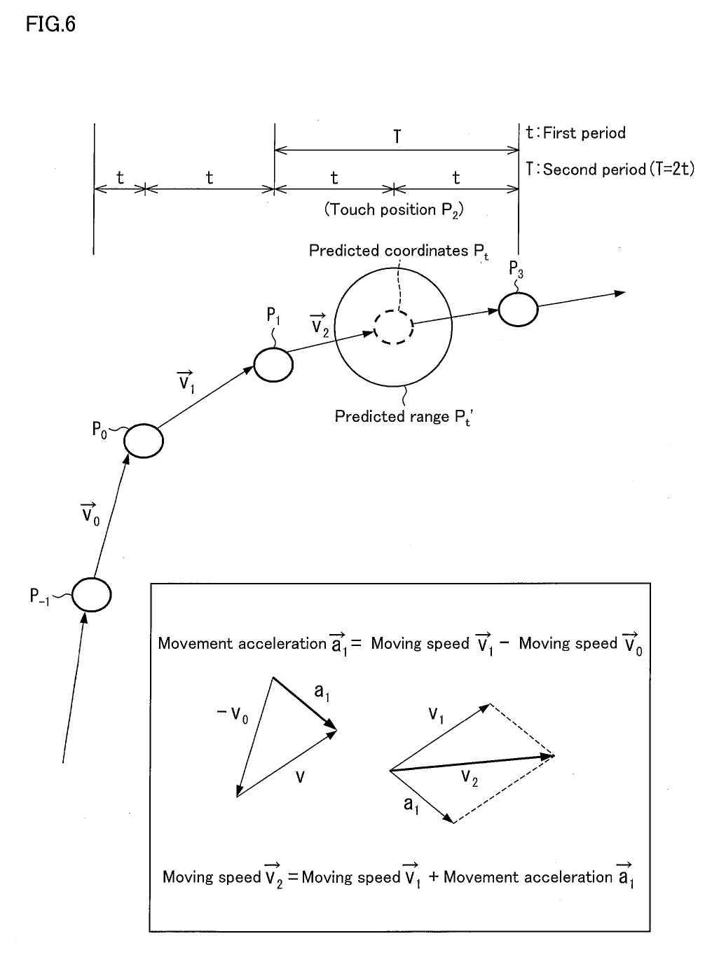

Another embodiment of the present invention is described below with reference to FIGS. 5 and 6. Note that, for convenience, identical reference numerals are given to members having respective functions identical to those of the members described in Embodiment 1, and descriptions of those members are omitted in Embodiment 2. Further, the following particularly discusses a difference from Embodiment 1, i.e., a process of the touch information compensating section 56.

(Another Process of Touch Information Compensating Section 56)

In Embodiment 1, the touch information compensating section 56 compensates a missing piece of touch information by interpolation. In Embodiment 2, the touch information compensating section 56 compensates a missing piece of touch information by setting predicted coordinates Pt or a predicted range Pt′ whose center is at the predicted coordinates Pt.

FIG. 5 is a flowchart illustrating a process of the touch information compensating section 56 of a touch panel system 1 according to Embodiment 2 of the present invention. FIG. 6 is a view schematically illustrating the process of the touch information compensating section 56 of the touch panel system 1 according to Embodiment 2 of the present invention.

As illustrated in FIG. 5, the touch position detecting section 5 processes a signal, supplied from the touch panel 3, at a predetermined scanning cycle so as to detect a touch position (S11). Specifically, when a touch operation is carried out with respect to the touch panel 3, the touch position calculating section 55 (i) calculates a current touch position on the basis of a changed amount of capacitance of the touch panel 3, and (ii) supplies a result of the calculation to the touch information compensating section 56 (touch information storage section 56a).

Next, the touch information storage section 56a stores therein the touch information (e.g., relative time, coordinates, and the like of the detected touch position) calculated by the touch position calculating section 55 (S12). In a case where a continuous touch operation is carried out on the touch panel 3, the touch position detecting section 5 continuously detects touches during the touch operation, and accordingly, the touch information storage section 56a continuously stores therein pieces of touch information during the touch operation.

Next, the missing determining/compensating section 56b (i) reads out the touch information stored in the touch information storage section 56a and (ii) sets predicted coordinates or a predicted range for determining whether or not a piece of touch information is missing (S13). Specifically, the missing determining/compensating section 56b sets, based on a touch operation record stored in the touch information storage section 56a, the predicted coordinates Pt and the predicted range Pt′, whose center is at the predicted coordinates Pt, for predicting a touch position after touch positions that have been detected. Here, the missing determining/compensating section 56b calculates the predicted coordinates Pt and the predicted range Pt′, based on (a) a previous touch position, (b) a moving speed of the previous touch position, and (c) a moving acceleration of the previous touch position, with respect to a touch position detected at a certain time point (S13).

The following discusses a method for setting the predicted coordinates Pt and the predicted range Pt′ with reference to FIG. 6. FIG. 6 illustrates an example in which, as with the case of FIG. 4, (i) touch positions are detected at a touch position P₋₁, →a touch position P₀, →a touch position P₁→a touch position P₃ . . . in this order, and (ii) a piece of touch information of a touch position P₂ is missing. FIG. 6 also illustrates the predicted coordinates Pt and the predicted range Pt′ whose center is at the predicted coordinates Pt, where the predicted coordinates Pt and the predicted range Pt′ are calculated by the missing determining/compensating section 56b and correspond to the missing touch position P₂. Further, FIG. 6 illustrates (a) a touch position moving speed V₀ from the touch position P₋₁ to the touch position P₀, (b) a touch position moving speed V₁ from the touch position P₀ to the touch position P₁, and (c) a touch position moving speed V₂ from the touch position P₁ to the predicted coordinates Pt (missing touch position P₂).

Note that, in the example of FIG. 6, the predicted range Pt′ is set so as to have a circular shape whose center is at the predicted coordinates Pt. However, a method for setting the predicted range Pt′ is not limited to such a circular shape. That is, the predicted range Pt′ can be set based on a touch operation record or the like. For example, as with the predicted coordinates Pt, the predicted range Pt′ can be set based on (a) a previous touch position, (b) a previous touch position moving speed, and (c) a previous touch position movement acceleration, with respect to a touch position detected at a certain time point.

The touch position moving speed is calculated based on a distance and a moving time between arbitrary two touch positions. A movement acceleration a₁ from the touch position P₁ to the touch position P₂ is calculated based on a difference between the touch position moving speed V₁ and the touch position moving speed V₀ (i.e., the movement acceleration a₁=the touch position moving speed V₁—the touch position moving speed V₀). Further, the predicted coordinates Pt are calculated based on a touch position, a touch position moving speed, and a touch position movement acceleration. That is, the predicted coordinates Pt are calculated on the basis of a prediction that a touch position (touch position P₁) just before a missing touch position has moved from the touch position P₁ at the moving speed V₂ and with the movement acceleration a₁ (i.e., predicted coordinates Pt=touch position moving speed V₂+touch position movement acceleration a₁). The touch position moving speed and the movement acceleration are calculated by using the touch information stored in the touch information storage section 56a and are stored in the touch information storage section 56a. The predicted coordinates Pt are calculated by the missing determining/compensating section 56b with the use of values stored in the touch information storage section 56a.

Next, the missing determining/compensating section 56b (i) reads out the pieces of touch information stored in the touch information storage section 56a, (ii) determines, based on a comparison with the predicted coordinates Pt or the predicted range Pt′, whether or not a piece of touch information is missing during a continuous touch operation and, in a case where a piece of touch information is missing, (iii) compensates the missing piece of touch information (S14 through S16).

The missing determining/compensating section 56b first reads out the pieces of touch information stored in the touch information storage section 56a at every first period (t). In a case where a period from detection of a certain touch position to detection of a next touch position is (i) longer than the first period (t) and (ii) within a second period (T; and T>t), the missing determining/compensating section 56b determines that a piece of touch information (touch position detection result) is missing. In the present embodiment, the missing determining/compensating section 56b determines that a piece of touch information (a touch position detection result) is missing, in a case where, after the certain touch position was detected, (i) no touch has been detected at the predicted coordinates Pt or in the predicted range Pt′ within the first period (t) and (ii) a next touch has been detected within the second period (T). In the example of FIG. 6, the missing determining/compensating section 56b sets (i) a scanning cycle as the first period (t) and, (ii) as the second period (T), a period that is twice the scanning cycle. That is, the missing determining/compensating section 56b (i) reads out a piece of touch information at every scanning cycle (t=scanning cycle) and (ii) checks whether or not a period (interval) from (a) a piece of touch information having been read out at a certain time point to (b) another piece of touch information having been read out subsequently to the certain time point is within twice the scanning cycle (T=2t=scanning cycle×2), so as to determine whether or not a piece of touch information is missing. In FIG. 6, (i) no touch information is detected at the predicted coordinates Pt and within the predicted range Pt′ t second(s) after detection of a piece of touch information of the touch position P₁ and (ii) a piece of touch information of the touch position P₃ is detected 2t second(s) after the detection of the piece of touch information of the touch position P₁. In this case, the missing determining/compensating section 56b determines that a piece of touch information of the touch position P₂ is missing (YES in S14). In a case where (i) no touch information is detected at the predicted coordinates Pt or within the predicted range Pt′, which have been set based on pieces of touch information before the missing touch position P₂, within the first period (t) from the previous touch position P₁ and (ii) a next piece of touch information (touch position P₃) is detected within the second period (T), the missing determining/compensating section 56b determines that a piece of touch information is missing. That is, the missing determining/compensating section 56b determines that a piece of touch information is missing, in a case where (i) no touch information corresponding to the predicted coordinates Pt or the predicted range Pt′ has been detected and (ii) no touch has been detected within the second period (T) set based on the scanning cycle.

In such a case where the piece of touch information is missing, the missing determining/compensating section 56b compensates the missing piece of touch information and outputs the compensated piece of touch information to the touch information storage section 56a (S15). Specifically, in a case where the piece of touch information is missing, the missing determining/compensating section 56b outputs, to the touch information storage section 56a, touch information of the predicted coordinates Pt or the predicted range Pt′ as the compensated piece of touch information. The touch information storage section 56a stores therein the compensated piece of touch information thus outputted from the missing determining/compensating section 56b.

In contrast, in a case where (i) the piece of touch information of the touch position P₂ is detected t second(s) after the detection of the piece of touch information of the touch position P₁ and (ii) the piece of touch information of the touch position P₃ is detected 2t second(s) after the detection of the touch position P₁ in FIG. 6, the missing determining/compensating section 56b determines that no touch information is missing (NO in S14). In this case, the missing determining/compensating section 56b outputs the pieces of touch information of the continuous touch operation without compensating any piece of touch information (S16).

Note that, in a case where another piece of touch information is detected subsequent to the second period (T) after the detection of the touch position P₁ in FIG. 6, the missing determining/compensating section 56b determines that a touch operation including the another piece of touch information is separated from the touch operation including the touch position P₀→the touch position P₁ (this case is not particularly illustrated). Meanwhile, in a case where no touch information is detected subsequent to the second period (T) after the detection of the touch position P₁ in FIG. 6, the missing determining/compensating section 56b determines that the continuous touch operation is ended at the touch position P₁.

By repeating the above processes, the touch panel system 1 recognizes a continuous touch operation, and compensates a piece of touch information if any piece of touch information is missing. Note that the first period (t) and the second period (T), which are set by the missing determining/compensating section 56b, are not limited to the above example. A person skilled in the art would be able to set the first period (t) and the second period (T) based on empirical rules.

As described above, the touch panel system 1 of the present invention includes the touch information compensating section 56 which sets, based on the touch position (touch position P₁) detected before the missing touch position (touch position P₂), the predicted coordinates Pt or the predicted range Pt′ of the missing touch position (touch position P₂). Further, the touch information compensating section 56 compensates a piece of touch information of the missing touch position (touch position P₂) at the predicted coordinates Pt or within the predicted range Pt′.

That is, the touch information compensating section 56 (i) predicts, based on a touch position detected before the missing touch position (touch position P₂), i.e., a touch position detection record, a direction in which and a distance by which the missing touch position (touch position P₂) moves from the touch position detected before the missing touch position (touch position P₂) and (ii) sets the predicted coordinates Pt or the predicted range Pt′ of the missing touch position. Further, the touch information compensating section 56 compensates a piece of touch information of the missing touch position at the predicted coordinates Pt or within the predicted range Pt′. This makes it possible to compensate the piece of touch information of the missing touch position with high accuracy in a case where a moving amount between touch positions respectively detected before and after the missing touch position is small (i.e., in a case where touch positions smoothly vary).

In the touch panel system 1 of the present embodiment, the touch information compensating section 56 sets the predicted coordinates Pt or the predicted range Pt′ based on the touch position, the touch position moving speed, and the touch position movement acceleration.

That is, the touch information compensating section 56 sets the predicted coordinates Pt or the predicted range Pt′ based on the touch position, the touch position moving speed, and the touch position movement acceleration as the touch position detection record. From this, a process of setting the predicted coordinates Pt or the predicted range Pt′ is simplified. Moreover, accuracy of the predicted coordinates Pt or the predicted range Pt′ is heightened. It is therefore possible to rapidly compensate the touch information relating to the missing touch position with high accuracy.

### Embodiment 3

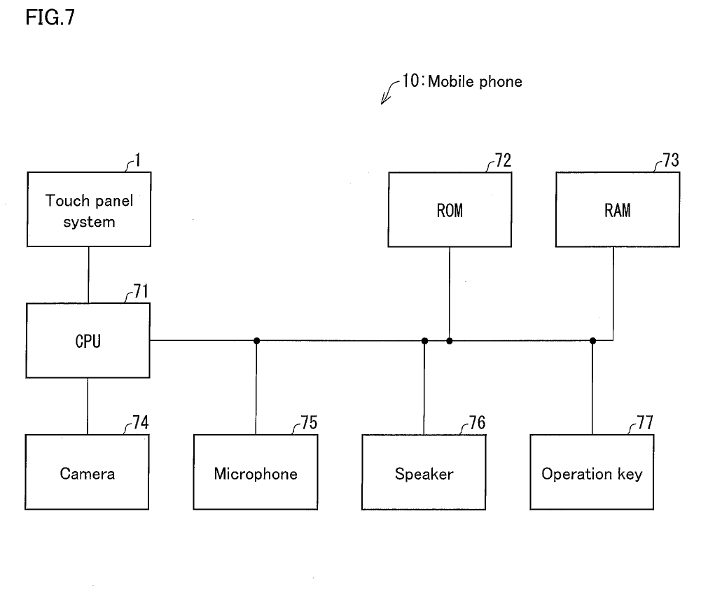

FIG. 7 is a functional block diagram illustrating a configuration of a mobile phone 10 including the touch panel system 1. The mobile phone (electronic device) 10 includes a CPU 71, a RAM 73, a ROM 72, a camera 74, a microphone 75, a speaker 76, an operation key 77, and the touch panel system 1. These components are connected to each other via a data bus.

The CPU 71 controls an operation of the mobile phone 10. The CPU 71 executes a program stored in, for example, the ROM 72. The operation key 77 is used by a user of the mobile phone 10 to enter instructions. The RAM is a volatile memory which stores therein (i) data generated when the CPU 71 has executed the program or (ii) data entered via the operation key 77. The ROM 72 is an involatile memory which stores data therein.

The ROM 72 is a ROM, such as an erasable programmable read-only memory (EPROM) or a flash memory, into which data can be written or from which data can be deleted. Note that, although not illustrated in FIG. 7, the mobile phone 10 can have an interface (IF) for being connected with another electronic apparatus via a wire.

The camera 74 takes an image of a subject in accordance with a user's operation of the operation key 77. Note that the image data of the subject thus taken is stored in the RAM 73 or an external memory (e.g., a memory card). The microphone 75 accepts audio from a user. The mobile phone 10 digitizes the audio (analog data) thus accepted, and transmits the audio thus digitized to a destination (such as other mobile phone). The speaker 76 outputs sounds based on data such as music data stored in the RAM 73.

The CPU 71 controls an operation of the touch panel system 1. The CPU 71 executes a program stored in, for example, the ROM 72. The RAM 73 is a volatile memory which stores therein data generated when the CPU 71 has executed the program. The ROM 72 is an involatile memory which stores data therein. The touch panel system 1 displays images stored in the ROM 72 and/or in the RAM 73.

Further, the present invention can be described as the following.

[Main Points]

A touch panel system 1 according to Aspect 1 of the present invention is a touch panel system including: a touch panel 3; and a touch position detecting section 5 for detecting a touch position on the touch panel 3, the touch position detecting section 5 including a touch information compensating section 56, and in a case where a period from detection of a certain touch position to detection of a next touch position during a continuous touch operation is longer than a first period (t) and within a second period (T; and T>t), the touch information compensating section 56 (i) determining that a touch position detection result is missing and (ii) compensating a piece of touch information of a missing touch position between the certain touch position and the next touch position.

According to the above arrangement, the touch information compensating section 56 (touch information storage section 56a, missing determining/compensating section 56b) determines, based on detection times of two touch positions that have been successively detected during a continuous touch operation, whether or not a touch position detection result is missing (i.e., presence or absence of a missing piece of touch information). In a case where the touch information compensating section 56 determines that there is a missing touch position, the touch information compensating section 56 compensates a piece of touch information relating to the missing touch position (touch position P₂) between the two touch positions (touch position P₁, touch position P₃). Consequently, it is possible to accurately recognize a touch operation even in a case where the touch position detection result (touch information) is missing during the touch operation.

The touch panel system 1 according to Aspect 2 of the present invention is preferably arranged such that, in Aspect 1, the touch information compensating section 56 (missing determining \compensating section 56b) compensates the piece of touch information of the missing touch position (touch position P₂) by interpolation using pieces of touch information of touch positions (touch position P₁, touch position P₃) respectively detected before and after the missing touch position (touch position P₂).

This makes it possible to compensate the piece of touch information of the missing touch position (touch position P₂) with high accuracy even in a case where the touch positions (touch position P₁, the touch position P₃) respectively detected before and after the missing touch position notably vary.

The touch panel system 1 according to Aspect 3 of the present invention is preferably arranged such that, in Aspect 1 or 2, the touch information compensating section calculates the piece of touch information of the missing touch position by averaging the touch positions respectively detected before and after the missing touch position.

According to the above arrangement, since the touch information compensating section 56 calculates the piece of touch information of the missing touch position (touch position P₂) by averaging, a setting process for the piece of touch information of the missing touch position (touch position P₂) is simplified. It is therefore possible to rapidly compensate the piece of touch information relating to the missing touch position (touch position P₂) with high accuracy.

The touch panel system 1 according to Aspect 4 of the present invention can be arranged such that, in Aspect 1 or 2, the touch information compensating section 56 (i) sets, based on a touch position (touch position P₁) detected before the missing touch position (touch position P₂), predicted coordinates Pt or a predicted range Pt′ of the missing touch position (touch position P₂) and (ii) compensates the piece of touch information of the missing touch position (touch position P₂) at the predicted coordinates Pt or within the predicted range Pt′.

According to the above arrangement, the touch information compensating section 56 (i) predicts, based on a touch position detected before the missing touch position (touch position P₂), i.e., a touch position detection record, a direction in which and a distance by which the missing touch position (touch position P₂) moves from the touch position detected before the missing touch position (touch position P₂) and (ii) sets the predicted coordinates Pt or the predicted range Pt′ of the missing touch position. Further, the touch information compensating section 56 compensates a piece of touch information of the missing touch position at the predicted coordinates Pt or within the predicted range Pt′. This makes it possible to compensate the piece of touch information of the missing touch position with high accuracy in a case where a moving amount between touch positions respectively detected before and after the missing touch position is small (i.e., in a case where touch positions smoothly vary).

The touch panel system 1 according to Aspect 5 of the present invention is preferably arranged such that, in Aspect 4, the touch information compensating section 56 sets the predicted coordinates Pt or the predicted range Pt′ based on a touch position, a touch position moving speed, and a touch position movement acceleration.

According to the above arrangement, the touch information compensating section 56 sets the predicted coordinates Pt or the predicted range Pt′ based on the touch position, the touch position moving speed, and the touch position movement acceleration as the touch position detection record. From this, a process of setting the predicted coordinates Pt or the predicted range Pt′ is simplified. Moreover, accuracy of the predicted coordinates Pt or the predicted range Pt′ is heightened. It is therefore possible to rapidly compensate the touch information relating to the missing touch position with high accuracy.

The touch panel system 1 according Aspect 6 of the present invention can be arranged such that, in any one of Aspects 1 through 5, the touch panel is a projected capacitive type touch panel.

According to the above configuration, since the touch panel system 1 includes the touch panel whose operation principle is the projected capacitive type, it is possible to provide a touch panel system capable of accepting multi-touch (multi-point detection).

The touch panel system 1 according to Aspect 7 of the present invention can further include, in any one of Aspects 1 through 6, a display device and can be arranged such that the touch panel is provided on a front surface of the display device.

According to the arrangement, since the touch panel is provided on the front surface of the display device, it is possible to prevent erroneous recognition of noise as a touch position which noise has occurred in the display device.

The touch panel system 1 according to Aspect 8 of the present invention can be arranged such that, in any one of Aspects 1 through 7, the display device is a liquid crystal display, a plasma display, an organic EL display, a field emission display, or a display having an InGaZnO-based oxide semiconductor.

According to the above configuration, the display device is made up of any of the above displays that are widely used in electronic devices for daily use. This makes it possible to provide a touch panel system having high versatility. Further, the display device 2 having the InGaZnO-based oxide semiconductor can realize display of a high definition image with greatly reduced electric power consumption.

An electronic device according to Aspect 8 of the present invention includes, in any one of Aspects 1 through 8, any one of the above described touch panel systems.

Therefore, it is possible to provide an electronic device that can prevent erroneous recognition of a touch operation.

The present invention is not limited to the embodiments, but can be altered by a skilled person in the art within the scope of the claims. An embodiment derived from a proper combination of technical means disclosed in respective different embodiments is also encompassed in the technical scope of the present invention. Further, it is possible to form a new technical feature by combining the technical means disclosed in the respective embodiments.

### INDUSTRIAL APPLICABILITY

The present invention is applicable to various electronic devices each of which includes a touch panel. The various electronic devices encompass a television, a personal computer, a mobile phone, a digital camera, a portable game device, an electronic photo frame, a mobile information terminal, an electronic book, household electric appliances, a ticket vending machine, an ATM, a car navigation device, and the like.

### REFERENCE SIGNS LIST

1 Touch Panel System
2 Display Device
3 Touch Panel
5 Touch Position Detecting Section
10 Mobile Phone (Electronic Device)
56 Touch Information Compensating Section
56a Touch Information Storage Section
56b Missing Determining/compensating Section

1.-5. (canceled)

6. A touch panel system comprising:
a touch panel; and
a touch position detecting section for detecting touch positions on the touch panel,
the touch position detecting section including a touch information compensating section for compensating a missing piece of touch information which is missing during a continuous touch operation,
the touch information compensating section including a touch information storage section and a missing determining/compensating section,
the touch information storage section stores therein pieces of touch information relating to the touch positions,
the missing determining/compensating section (i) reading out the pieces of touch information stored in the touch information storage section, (ii) determining whether or not a piece of touch information is missing during the continuous touch operation, and in a case where a piece of touch information is missing, (iii) setting predicted coordinates or a predicted range of a missing touch position based on the pieces of touch information stored in the touch information storage section, and (iv) compensating the piece of touch information of the missing touch position at the predicted coordinates or within the predicted range.

7. The touch panel system as set forth in claim 6, wherein:
the touch information compensating section sets the predicted coordinates or the predicted range based on a touch position, a touch position moving speed, and a touch position movement acceleration.

8. The touch panel system as set forth in claim 6, wherein:
in a case where a period from detection of a certain touch position to detection of a next touch position during a continuous touch operation is longer than a first period (t) and within a second period (T; and T>t), the missing determining/compensating section (i) determines that a touch position detection result is missing and (ii) compensates a piece of touch information of a missing touch position between the certain touch position and the next touch position.
